(19) United States
(12) Patent Application Publication
(10) Pub. No.: US 2011/0070570 A1
(43) Pub. Date: Mar. 24, 2011

(54) ELECTRONIC TEACHING SYSTEM INCORPORATING MAGNETS IN AN INSULATING BASEBOARD

(76) Inventor: Stewart Dunn, Milton Keynes (GB)

(21) Appl. No.: 12/994,563

(22) PCT Filed: May 28, 2009
(86) PCT No.: PCT/GB09/01301

§ 371 Date: Nov. 24, 2010

(30) Foreign Application Priority Data
May 31, 2008 (GB) 0809961.6

(51) Int. Cl. G09B 23/18

(52) U.S. Cl. 434/301

(57) ABSTRACT

An insulating baseboard which contains within itself a number of embedded magnets, accessible from top and bottom surface, which locate and hold in place component holders on which can be located ferromagnetic rods which when assembled combine to create electronic circuits. The component holders include eyelet cores and may include electronic components which align themselves with the magnets embedded in the baseboard and in turn hold in place ferromagnetic rods positioned on top of the eyelet cores. The ferromagnetic rods lie in a horizontal plane above and in parallel with the insulating baseboard and in-line or at 90 degrees to each other when viewed from above to produce a working circuit that replicates standard schematic circuit diagrams. Non-friction vertical connections can be made by means of connecting wires having ferromagnetic ends and which are held in place within the hollow part of the eyelet core by magnetism.

In my patent application GB 2442251 I disclosed ‘Methods and means of Assembling Electric/Electronic Kits’. It has now been shown that there is a potential safety concern for younger children which came to the fore when the toy industry recalled magnetic toys that use powerful small magnets. In the USA a child died after swallowing small powerful magnets. This death was caused by magnets attracting each other and rupturing a child's intestine.

My new invention addresses this safety concern by encapsulating all the magnets 2 used in a insulating baseboard 1 that is too large to swallow. To ensure it is approved I have had professional safety tests carried out and my new system has now passed the toy safety tests for small powerful magnets in toys. My new teaching system is based on the use of an insulating baseboard 1 into which are incorporated magnets 2 and upon which a working circuit is made by assembling component holders 3 and/or sub-system circuits 11. Both the component holders 3 and/or sub-system circuits 11 contain ferromagnetic eyelet cores 5 which in use are placed above the fixed magnets 2 in the insulating baseboard 1 and are held in place by the magnetic pull of the magnets 2.

The magnets 2 are housed in a fixed array pattern and embedded safely within the insulating baseboard 1 having part of the magnets top and bottom surface uncovered to allow electrical contact and onto which circuits are assembled so the component holders 3 are automatically lined up so that when viewed from above the assembled circuits replicate standard schematic electronic circuit diagrams used by professional electrical engineers on top of the component holders 3. Magnets 2 in the baseboard/can be accessed from both sides allowing circuits to be usefully used on both sides.
The rigid connecting ferromagnetic rods 8 complete the circuit by linking up component holders 3 and/or sub-system circuits 11 in most cases replacing the need for connecting wires. The rigid connecting ferromagnetic rods 8 may also have a sleeve 8b added making it easier to handle in use.

The strong magnetic flux provided by the powerful magnets such as those made from Neodymium-iron-boron transfer their magnetic flux up through the eyelet cores 5. There is enough magnetic flux to attract and hold a few ferromagnetic rods 8 placed on the eyelet cores 5 top surface thus enabling a circuit to be assembled in a single plane above the eyelet cores 5 providing a reliable circuit assemble system. The ferromagnetic eyelet cores 5 can take various forms including cylindrical and rectangle forms and may be rigid or connecting with a vertical hole in the top part or passing all the way through so that the ferromagnetic ends of the connecting wires 9 can be held in the hole of the eyelet core 5 by magnetic flux. Unlike standard mechanical plug and sockets the eyelet cores 5 can also support and electrically connect more than one connection at once in each eyelet core 5. The magnetic flux within the hole in the eyelet cores 5 is strong enough to ensure electrical contact is made without the need for the normal friction grip. To ensure the horizontal ferromagnetic rods 8 are not easily knocked off the top of the eyelet cores they have connection guides 6 that prevents this.

The component holder 3 and larger more complex variations called sub-system circuits 11 consist of two or more eyelet cores 5 and may contain one or more electrical components 7 such as a resistor or heat sensor and has the corresponding electronic symbol 7 or description on the top or bottom surface. Electrical components 4 can be mounted above or below the component holder body 3b or enclosed within the component holder 3 and sub-system circuits 11 thus freeing surface areas to accommodate electronic symbols 7 on the electronic components 4 or sub-system circuits 11 surfaces.

When required the insulating body of the component holder 3 body may be made from a material transparent to light and/or sound.

Component holder 3 may also contain signal cores so that processing signals can enter and/or exit the component holder 3.

Circuits using this system can be assembled without using tools, solder, screws, connecting wires, sockets, frictional force or mechanical connectors as has been necessary before.

Whilst it may be possible to hold magnets 2 frictionally in a baseboard and add adhesive if required it is preferable to use a base board 1 made from two parts which when glued together hold the magnets 2 in place by a lip of plastic below and above the magnets 2.

### PRIOR ART

### GB 2442251

In this patent application I describe a method of assembling electric or electronic circuits making use of links comprising electrically conductive magnetic or ferromagnetic cores contained within and insulating board 3, the upper and/or lower surfaces and/or the sides of the cores being accessible for electrical contact with the other cores or components.

An advantage of this system described is that it can be constructed without need for a baseboard and this system works well in practice. However recent changes in toy safety regulations will in future prohibit the sale of powerful magnets or objects containing powerful magnets which may be used by small children, unless the size of the object is such as to prevent them being swallowed. Current thinking in the EU suggests a min of 2.5 inches long.

I have now developed a method of assembling electronic circuits which is safe for use by younger children by ensuring that all the magnets are contained in parts that are too large to swallow.

This patent uses a breadboard layout with internally connected power pads for ‘electric short’ and ‘ground pads’ which are adjacent to one another and includes an ‘interconnecting sheet’ formed of a thin metal plate and ‘film sheet’ made of an insulating material within the breadboard.

The breadboard construction technique used prevents standard circuit diagrams being ‘drawn out’ to replicate standard circuit diagrams correctly when viewed from above.

The parts which contain magnets are small enough to be swallowed. In my new system none of the above applies.

### GB 2,205,985

In this patent I described a versatile construction kit for the teaching of electric/electronic circuitry theory. One of the advantages of this invention is that when viewed from above the theoretical circuits made using the kit closely resemble the standard theoretical schematic circuit diagrams shown in electrical circuit textbooks. The system is based upon the use of an electrically insulating baseboard into which are incorporated ‘clusters’ of electrical connecting points (sockets) which do not significantly protrude above the top or bottom surface of the board. The clusters are two or more electrically connecting sockets electrically connected together and adapted to receive electrical conductors entering from the same direction. There are no magnets used in the baseboard.

### GB Patent 2,301,929

In this patent I disclosed significant technical flexibility and economic saving was achievable by making use of ‘dedicated cluster’ and/or dedicated ‘cluster component boards’ that could carry individual components with circuit symbols which are linked together with wires on an electrically insulating board which contains a number of spatially related holes, preferably in a regular grid pattern, into which pegs or click-rivets can be inserted and removed.

My new system includes many of these advantages but requires magnets to hold the parts together rather than using standard ‘friction sockets connectors’.

This patent discloses magnets used to fix the movable electronic part holders anywhere on the steel covered base plate making using use of magnetic attraction. making using use of magnetic attraction.

There are no magnets used in the baseboard.

### NZ Patent 299,897

Discloses a component comprising a strip of electrically insulating permanently magnetic material one surface of which supports an electrically conductive material. The loose magnet strips lie on a steel sheet or are glued under movable carrier boards so that they can be anywhere on the steel sheet.

The components are placed on a large ferromagnetic (steel) base plate through which connections cannot pass.

There are no magnets used the baseboard.

EP Patent number 0526,090

This refers to component tiles and a mounting board, the board and the tiles having co-operable magnet means which holds the tiles magnetically in place on the board. There are no magnets used in the baseboard and do not form part of the circuit.

U.S. Pat. No. 2,166,036

The subject of this patent is the use of removable letters on a sign board. The sign boards are supported on a long pair of metal bars to which the letters are held in position by magnetic means. No baseboard is used with magnets.

U.S. Pat. No. 3,510,963

This patent discloses the use of magnets to hold panels on a steel sheet. The magnets are used to hold the panels on a mounting board. No baseboard with magnets and no other use is made of the magnetic flux to hold wires or links in place.

U.S. Pat. No. 4,010,555

This patent simply discloses a way of holding component parts on a board preferably using ceramic magnets on a steel display board. No magnets are used within the baseboard.

### REFERRING TO DRAWINGS

FIG. 1 shows a insulating baseboard 1, magnets 2 on which is mounted a component holder 3 comprising an electronic component 4 an eyelet core 5 with connection guide 6 and an electronic symbol 7.

FIG. 2 shows a larger drawing of a typical component holder 3 comprising an electronic component 4, eyelet cores 5 with connection guide 6 and an electronic symbol 7.

FIG. 3 shows an eyelet core 5 within a connection guide 6.

FIG. 4 is a variation of FIG. 3 showing an eyelet core 5 within a connection guide 6 that encloses more of the eyelet core 5.

FIG. 5 shows a cross sectional view of a component holder 3 on a insulating baseboard 1. The magnet 2 is embedded in the insulating baseboard 1. The eyelet core 5 is shown passing through part of a component holder 3 and a connection guide 6. The insulating board 1 may be made of a bottom and top half shown as 1a and 1b.

FIG. 6 is the same as FIG. 2 but shows a variation in the shape of the component holder body 3b.

FIG. 7 is shows a sectional view where the electronic component 4 is connected to the eyelet cores 5 under the top surface of the component holder body 3b.

FIG. 8 shows in 3D how a ferromagnetic rods 8 is placed on the top of the eyelet core 5 and located by a connection guide 6 which is part of the component holder 3.

FIG. 9 shows a top view of FIG. 8 and with a position sleeve 8b on a ferromagnetic rod 8.

FIG. 10 shows how connecting wire 9 with ferromagnetic end can be placed inside and connected to the eyelet core 5 of a component holder 3.

FIG. 11 shows how a connecting wires 9 with ferromagnetic ends can be inserted inside eyelet cores 5 of a component holder 3.

FIG. 12 shows a simple circuit made from two component holders 3 and two ferromagnetic rods 8 with three connecting wires 9 with ferromagnetic ends placed inside the eyelet cores 5 to link up to other circuits or test instruments.

FIG. 13 shows a component holder 3 with a two part component holder body 3b placed on a insulating baseboard 1 with magnets 2.

FIG. 14 shows two component holders 3 on the top surface of the insulating baseboard 1 with magnets 2 with another component holder 3 attached underneath the baseboard.

FIG. 15 shows two component holders 3 on the top surface of the insulating baseboard 1 with magnets 2 linked electrically by a ferromagnetic rod 8 and two connecting wires 9 with ferromagnetic ends

FIG. 16 and FIG. 17 shows two views of the same parts on an insulating baseboard 1

FIG. 17 is a front sectional view taken so that the magnets 2 can be seen in the insulated baseboard 1.

On the insulating baseboard 1 are magnets 2, seven component holders 3, an electronic component 4, eyelet cores 5, connection guides 6, electronic symbols 7, ferromagnetic rods 8, connecting wires 9 with ferromagnetic ends

FIG. 18 shows various component holders 3 on the top surface of insulating baseboard 1 with magnet 2 linked electrically by ferromagnetic rods 8 and connecting wires 9 with ferromagnetic ends connected to another circuit system 12. It also shows a sub-system circuit 11 in use. Component holders 3 have eyelet cores 5, connection guides 6, electronic component 4 and electronic symbols 7.

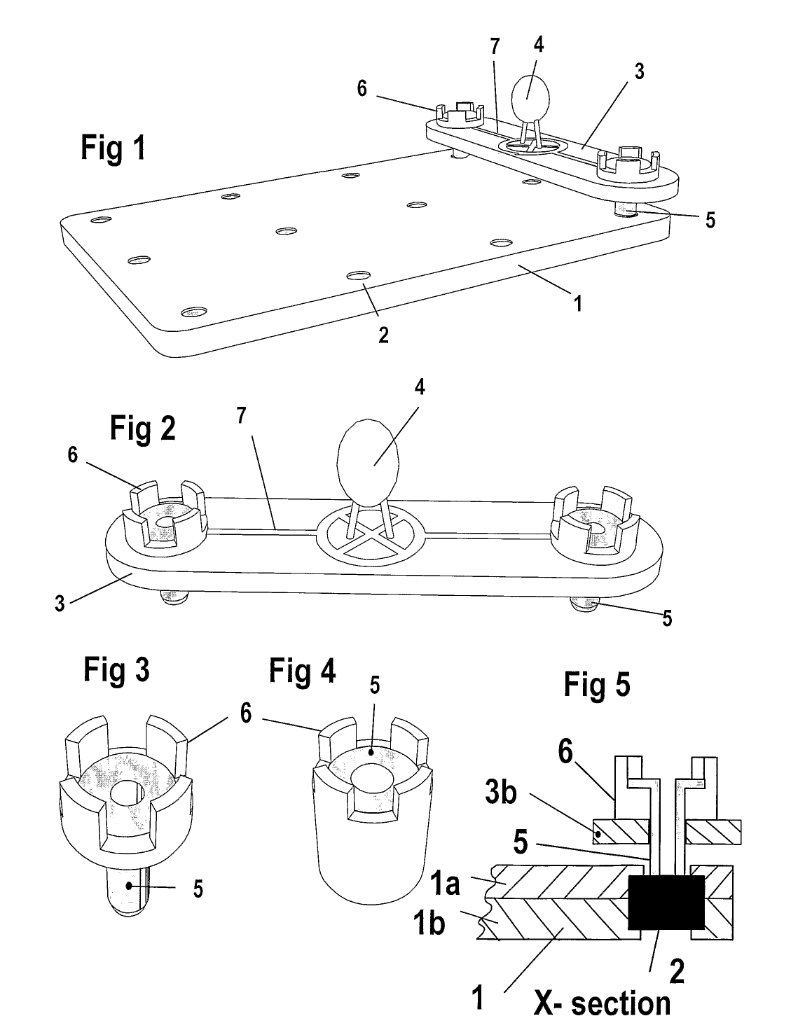

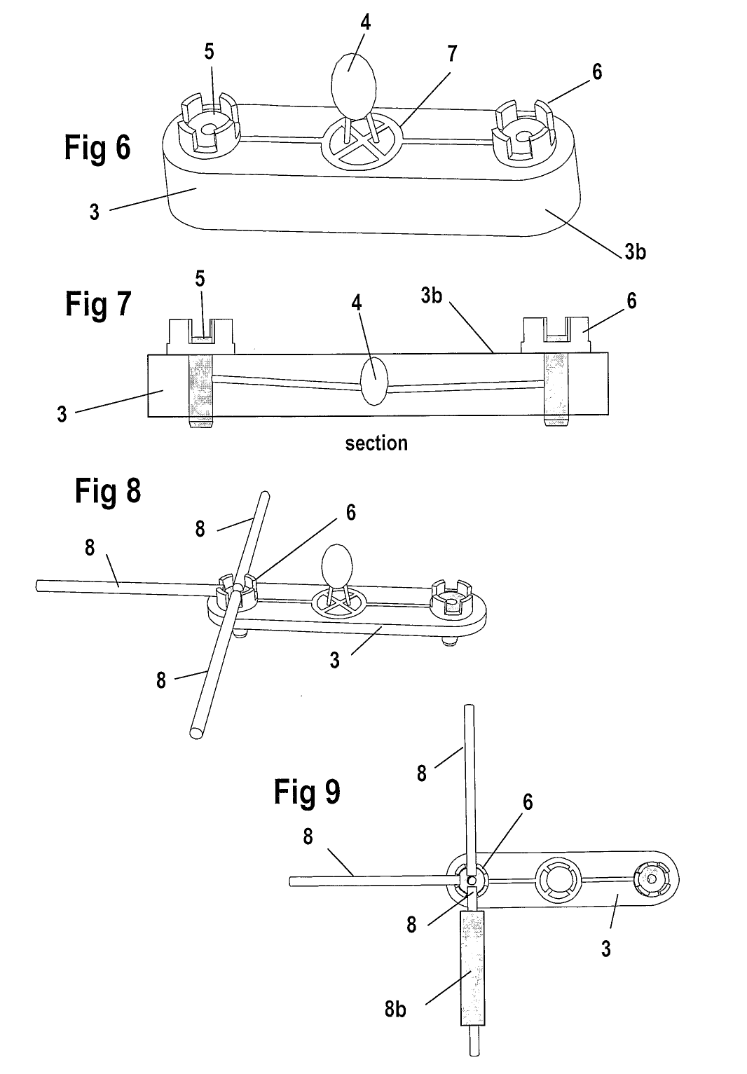

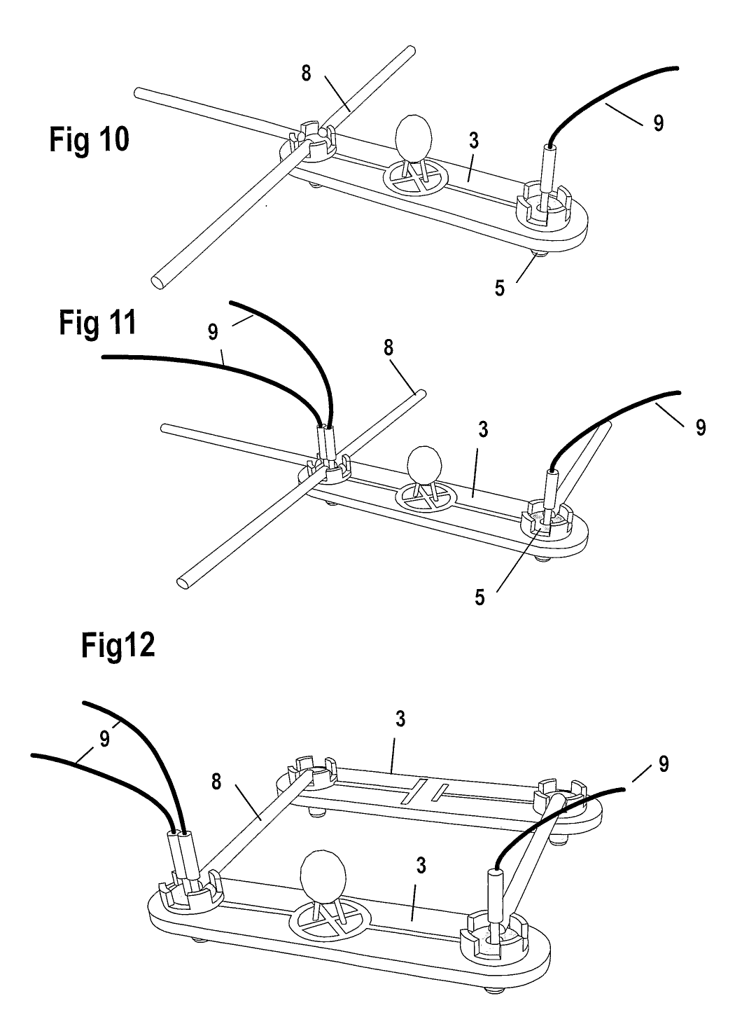

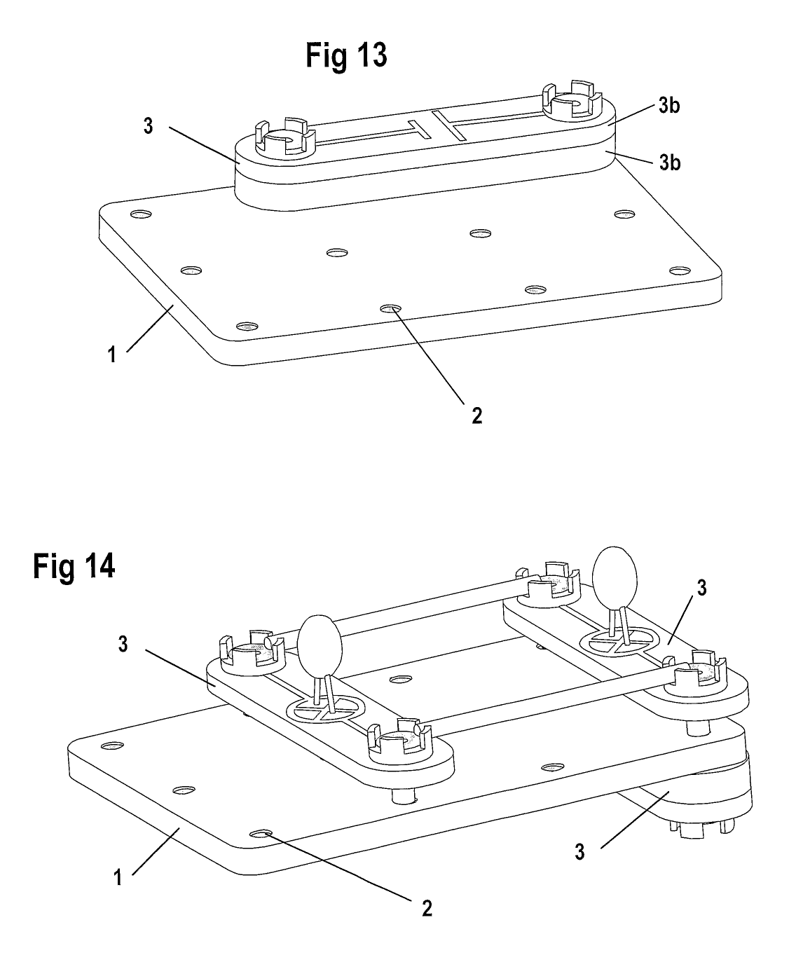

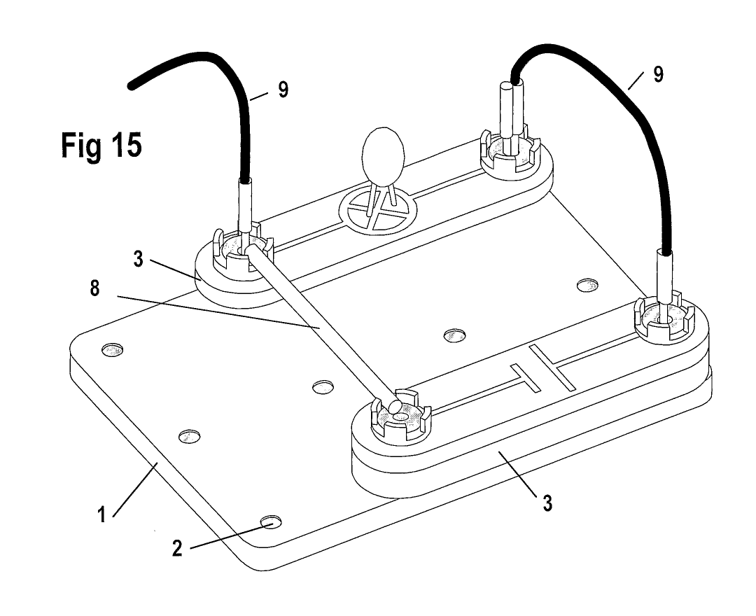

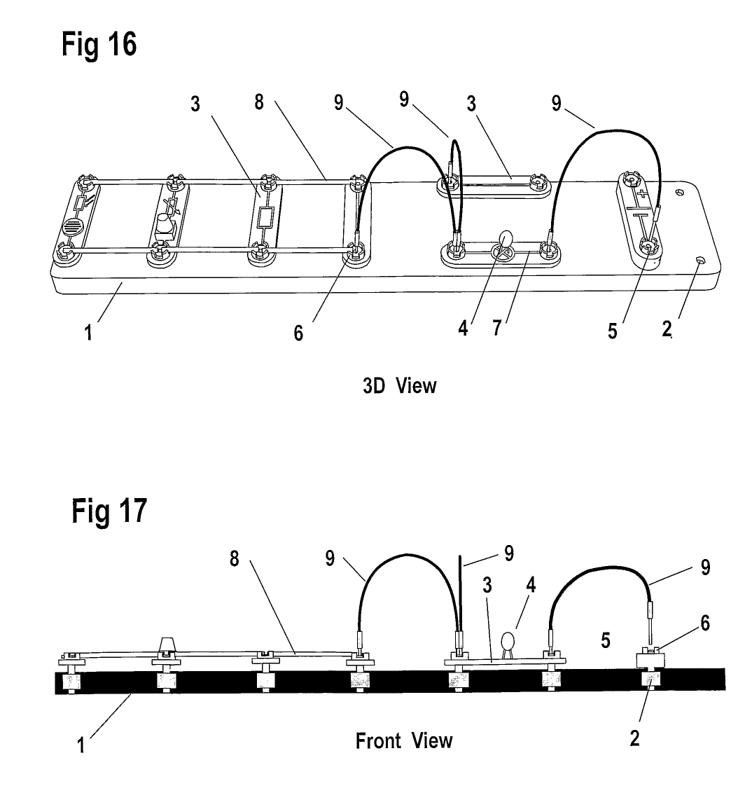

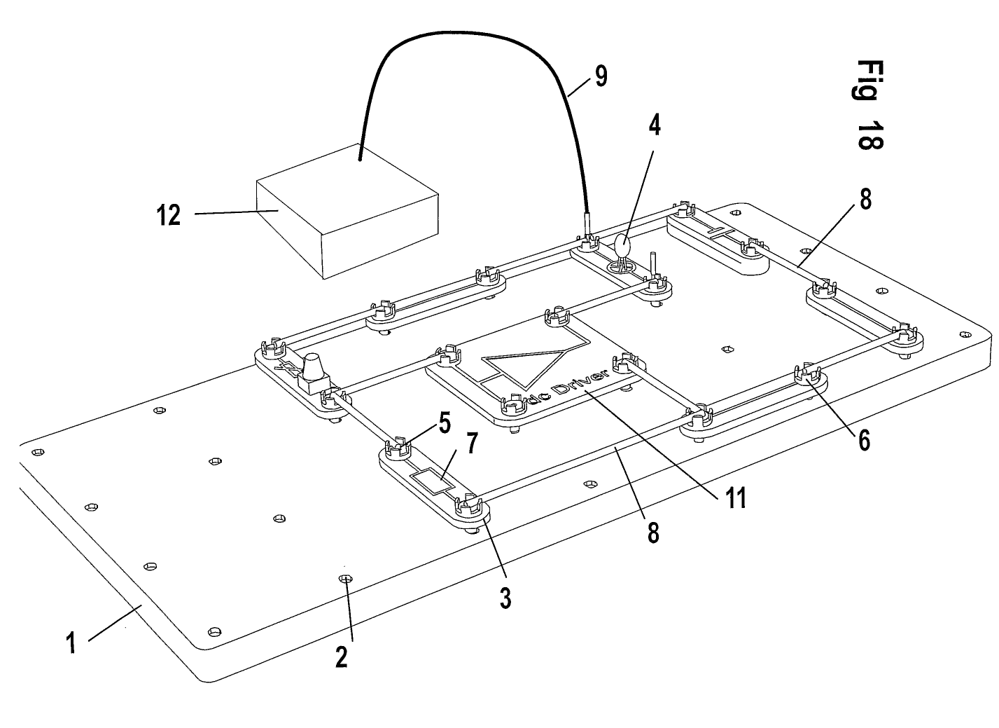

1.-14. (canceled)

15. A circuit building system comprising:
an insulating baseboard which contains, in a modular pattern, electrically conductive magnets of high magnetic flux that are partially but securely embedded within the baseboard, and
at least one component holder comprising at least two ferromagnetic cores held in place within the magnets, each eyelet core adapted to hold in place one or more connecting wires having a ferromagnetic end and/or one or more ferromagnetic rods,
wherein the magnets in the baseboard and the eyelet cores in the component holders have the same modular pattern, thereby permitting each component holder to engage a magnet in the baseboard.

16. A circuit building system according to claim 15 in which a component holder carries a sub-system circuit board.

17. A circuit building system according to claim 15 or 16 wherein assembled component holders and/or sub-system circuits are connected together by ferromagnetic rods which are held in place on eyelet cores by means of connection guides in the form of flanges.

18. A circuit building system according to claim 17 in which the ferromagnetic rods are laid on top of the eyelet cores in a single plane, in line with each other or at 90 degrees to each other.

19. A circuit building system according to claim 15 or 16 in which electric or electronic symbols are placed on a visible surface of the component holders or sub-system circuit boards.

20. A circuit building system according to claim 15 or 16 in which the assembled component holders or sub-system circuits can be located on both sides of the baseboard.

21. A circuit building system according to claim 15 in which the eyelet cores are hollow.

22. A circuit building system according to claim 21 wherein the assembled component holders and/or sub-system circuits are connected together by the ferromagnetic ends of connecting wires inserted into the hollow eyelet cores.

23. A circuit building system according to claim 21 in which the connecting wires are flexible.

24. A circuit building system according to claim 22 in which the connecting wires are rigid.
